(19) United States
(12) Patent Application Publication
(10) Pub. No.: US 2009/0248685 A1
(43) Pub. Date: Oct. 1, 2009

(54) Method, System and Apparatus for Matching Job Applicants with Job Openings

(76) Inventors: Jay Pasqualoni, Madison, CT (US); Harald M. Henning, Brookfield, CT (US); Raymond Tomasco, Mooresville, NC (US)

Correspondence Address: GORDON & JACOBSON, P.C., 60 LONG RIDGE ROAD, SUITE 407, STAMFORD, CT, 06902, US

(21) Appl. No.: 12/054,515

(22) Filed: Mar. 25, 2008

(51) Int. Cl. G06F 7/06

(52) U.S. Cl. 707/6; 707/E17.014

(57) ABSTRACT

A networked system for matching job applicants to employers and jobs is provided.

### BACKGROUND OF THE INVENTION

1. Field of the Invention

This invention relates broadly to methods, systems and apparatus for facilitating electronic commerce. More particularly, this invention relates to methods, systems and apparatus for matching job applicants with job openings of one or more employers.

2. State of the Art

The traditional employment agency business model involved an agent collecting information about a job opening with a particular employer, collecting information about applicants and then manually attempting to match applicants to the job. Information about job openings would be collected either by the agent cold calling potential employers or by employers contacting one or more agents. The agent would collect information about applicants in the same manner, either by cold calling potential applicants or by applicants submitting their resumes to the agent. The quality of the agent's service depended on the agent's knowledge of the employer's industry and the agent's good judgment of applicants.

Since desktop computing became affordable many applications have been created to assist agents in the process of matching applicants with jobs. Moreover, since the rise of the world wide web, many developers have attempted to provide employment agency style services in an electronic commerce manner. A well-known example is “monster.com”.

While many of the desktop applications and web sites provide services that surpass the traditional employment agency business model, they still leave much to be desired.

### SUMMARY OF THE INVENTION

The present invention provides a networked system that is driven by employers seeking to fill job openings.

According to the invention, a service provider maintains a networked system (including server logic as described below) for matching applicants (referred to herein as “job applicants”) to particular job openings of one or more employers. The employer operates a browser on a networked computer system to interact with server logic (i.e., a web site) maintained by or for the benefit of the service provider over a network (i.e., the Internet) to specify information about a particular job opening (referred to below as “job information”). The server logic stores the job information in a database, generates a Uniform Resource Locator (URL) associated with the particular job opening (referred to below as a “job-specific URL”), and communicates the job-specific URL to the employer (or other designated recipient). Such communication can be carried out over by interaction between server logic and the networked computer system or possibly through other external communications means (e.g., email, SMS, etc.). The employer (or designated recipient) then integrates the job-specific URL as part of a web page on the employer's web site. Job applicants operating a browser on a networked computer system access the employer's web site and employ the job-specific URL integrated therein to interact with the server logic. Such interaction collects data about each given job applicant and stores the information in the database and associates the job applicant with the particular job opening of the job-specific URL (the URL that initiated the data collection session with the given job applicant). The server logic includes matching logic that dynamically matches applicant information for one or more job applicants with the job-specific information for a given job opening and indicates whether any appropriate job applicants have been matched to the given job opening. The results of the matching logic are presented to the employer preferably by interaction between the employer operating a browser on a networked computer system and the server logic. The results can be presented to the employer (preferably under selective control of the employer) as a list of job applicants in alphabetical order and/or in a ranked order based on how well the job applicants' information matches the job information for the given job opening. Each entry of the list preferably provides a hyperlink to a page that displays the information for the corresponding job applicant.

According to one aspect of the invention, the matching logic is executed manually as dictated by user input from the employer. Alternatively, the matching logic can be executed automatically (i.e., at predetermined intervals or possibly when a new job applicant has interacted with the system for the given job opening).

According to another aspect of the invention, the server logic can automatically communicate to the employer (or a designated recipient) notifications when one or more new job applicants have interacted with the system for a given job opening of the employer and/or notifications when a job applicant with a better match than a previously viewed job applicant for a given job opening of the employer is identified by the results of the matching logic. Such communication can be carried out by the server logic (a message in an inbox for the employer as maintained by the server logic or possibly presented to the employer upon login) or through external means (i.e., email, SMS, etc.).

According to yet another aspect of the invention, the job information specified by the employer and maintained by the server logic includes five broad categories: basic information, job requirements, job characteristics, behavioral profile, and custom questions. The basic information includes what is found in a typical job listing: job title, job function, name of employer, and employer industry. The job requirements include three sub-categories: education, skills, and certifications. Job characteristics include three sub-categories: salary/benefits, location, and work environment (work schedule, team environment, job environment, work content, and a description of the corporate culture). Behavioral profile includes a scaled rating on behavioral preferences such as: detail orientation, risk orientation, social orientation, dependency orientation and achievement orientation. Such behavioral preferences are particularly relevant to corporate culture and provide more accurate matching. Custom questions may include questions such as: “Have you ever been convicted of a crime?”, “Are you a U.S. citizen?”, “Do you have a driver's license?”, etc.

According to yet another aspect of the invention, the applicant information collected by interaction between the job applicant and the server logic and maintained by the server logic includes five categories: contact information, background and training, desired job characteristics, behavioral profile, and answers to custom questions. The applicant information collected by the server logic is tailored to the job information of the particular job opening associated with the job-specific URL that is accessed by the job applicant to initiate the applicant information data collection session. Thus, background and training entry fields will answer specific questions based on the job requirements input by the employer. For example, “Do you have a Masters degree in computer science?” The desired job characteristics entry fields will answer specific questions based on the job characteristics input by the employer. For example, “What is your minimum salary requirement?” The behavioral profile entry fields will answer specific requirements based on the behavioral profile input by the employer. For example, “Are you comfortable working alone?” The answers to custom questions will be the answers to the custom questions input by the employer.

According to yet another aspect of the invention, the matching logic that compares the applicant information with the job information for a given job opening is based on a number of comparisons corresponding to predetermined criteria (e.g., nine criteria such as compensation, location, work environment, behavioral profile, education, experience, skills, certifications, and custom questions). Each comparison is graded on a scale, e.g. 0-100%. Grading is accomplished either by a mathematical equation, a binary comparison, or through a lookup table or equivalent. Preferably, weights (which represent a degree of relative importance) can be defined by the employer and applied to the grades (i.e., the result of the comparison for each criteria) to provide a weighted result indicating the overall result of the matching operating between the job information and the given job applicant. This weighted result can be used to rank the job applicants as being more or less suited for the given job opening. In the preferred implementation, such weighted result is calculated by multiplying each one of grades by its respective weight, summing the thus weighted grades, and dividing the sum by the sum of the weights, thereby producing a normalized score of the given job applicant of the particular job opening. In the preferred implementation, the job applicant can specify preferences that define importance of certain job characteristics (e.g., Unimportant, Minimal, Preferable, Required) through interaction between the job applicant and the server logic. Such applicant-defined importance preferences are stored in the database and used by the matching logic in deriving the grades over the categories of the particular job.

According to the illustrated implementation, once a job applicant access the job-specific URL, the job applicant may create an account maintained by the server logic and view job openings other than the one which initiated access of the job applicant to server logic. The applicant may also choose to have the applicant's information matched to all of the job openings maintained in the database and review a list of all matching job opening before applying for a particular job opening. Moreover, as applicant information and job information become available in the database, the matching logic can carry out automatic matching operations in the background and both employers and job applicants can be notified of new matches. Such notification can be communicated by the server (e.g., a message in an inbox maintained by the server logic or possibly a message presented upon login) or through external means (i.e., email, SMS, etc.).

Additional objects and advantages of the invention will become apparent to those skilled in the art upon reference to the detailed description taken in conjunction with the provided figures.

### BRIEF DESCRIPTION OF THE DRAWINGS

FIG. 1 is a block diagram illustrating a system for implementing the methods of the invention;

FIG. 2 is a high level flow chart illustrating the overall methods of the invention;

FIG. 3 is a high level flow chart illustrating an employer job entry session;

FIG. 4 is a high level flow chart illustrating an applicant data entry session;

FIG. 5 is a high level flow chart illustrating a job-applicant matching process;

FIGS. 6, 7, 8A, 8B, and 8C illustrate exemplary user interfaces generated by the system of FIG. 1 for the entry of job information by an employer;

FIGS. 9-11 illustrate exemplary user interfaces generated by the system of FIG. 1 for the entry of applicant information by an applicant; and

FIG. 12 illustrates an exemplary user interface generated by the system of FIG. 1 for displaying job-applicant matches.

### DETAILED DESCRIPTION

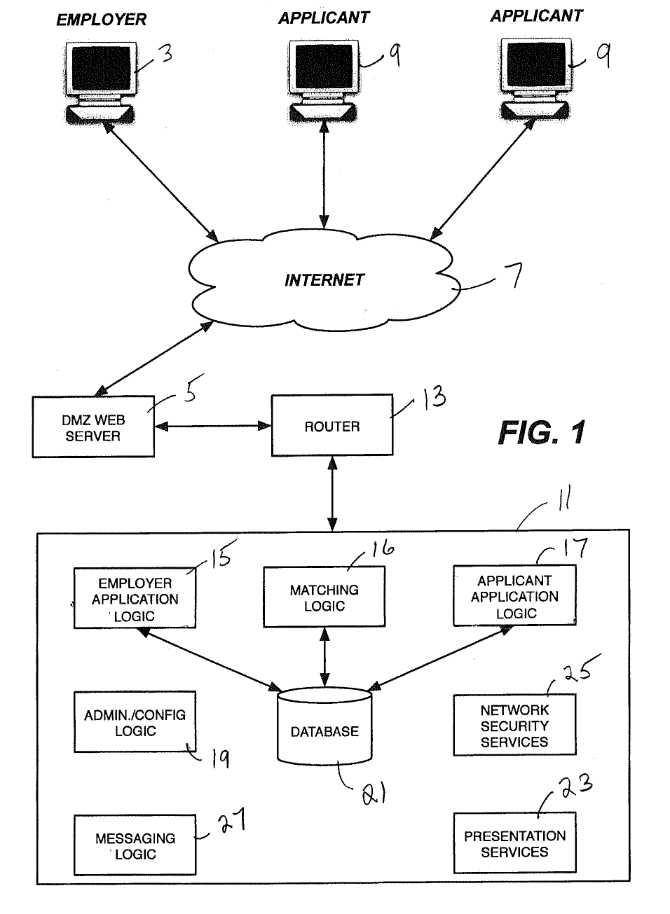

Turning now to FIG. 1, there is shown the architecture of an exemplary networked system in accordance with the present invention. A service provider maintains the networked system (including web server and application server logic as described below) for matching job applicants to particular job openings of one or more employers. As such, there are two classes (denoted “employers” and “job applicants”) of users of the networked system. The employer operates a browser on a networked computer system 3 to interact with the web server 5 and application server 11 maintained by or for the benefit of the service provider over a network 7 (i.e., the Internet) to specify information about a particular job opening (referred to herein as “job information”). The application server 11 stores the job information in a database 21, generates a Uniform Resource Locator (URL) associated with the particular job opening (referred to herein as “job-specific URL”), and communicates the job-specific URL to the employer (or other designated recipient). Such communication can be carried out over by interaction between server logic 11 and the networked computer system 3 or possibly through other external communications means (e.g., email, SMS, etc.). The employer (or designated recipient) then integrates the job-specific URL as part of a web page on the employer's web site (not shown). Job applicants operating a browser on a networked computer system 9 access the employer's web site and employ the job-specific URL integrated therein to interact with the web server 5 and application server 11. Such interaction collects data about each given job applicant and stores the information in the database 21 and associates the job applicant with the particular job opening of the job-specific URL (the URL that initiated the data collection session with the given job applicant). The application server 11 includes matching logic 16 that dynamically matches applicant information for one more job applicants with the job-specific information for a given job opening and indicates whether any appropriate job applicants have been matched to the given job opening. The results of the matching logic 16 are presented to the employer preferably by interaction between the employer operating a browser on the networked computer system 3 and the web server 5 and application server 11. The results can be presented to the employer (preferably under selective control of the employer) as a list of job applicants in alphabetical order and/or in a ranked order based on how well the job applicants' information matches the job information for the given job opening. Each entry of the list preferably provides a hyperlink to a page that displays the information for the corresponding job applicant.

As shown in FIG. 1, an employer utilizes a web browser executing on a computing device 3 to connect to a web server 5 over the network 7 (e.g., Internet). Similarly, a number of applicants each utilize a web browser executing on a computing device 9 to connect to the web server 5 over the network 7. Preferably, the browser-based interaction between the computing devices 3, 9 and the web server 5 occur over TCP/IP sessions established therebetween over which are communicated HTML-based (and possibly XML-based) documents and commands as well as other messages, commands and data. The web server 5 enables login and authentication of the employer via interaction with the employer computing device 3 as well as login and authentication of a respective applicant via interaction with the applicant system 9. Such login and authentication can utilize password-based authentication, operating system-based authentication (e.g., NTLM or Kerberos); services-based authentication (e.g., Microsoft Passport authentication), certificate-based authentication, or any other authentication scheme. Once a user session has been authorized (whether it be an employer session or an applicant session), the web server 5 communicates with an application server 11 to build dynamic web page(s) based on data supplied by the application server 11 and serve the dynamic web page(s) to the employer web browser (or the applicant web browser) as requested, and forward (and/or transform) data supplied by the employer web browser (or the applicant web browser) to the application server 11 as needed. Preferably, the web server 5 is located in a “demilitarized zone” (DMZ) provided with a firewall router 13. In this configuration, the firewall/router 13 enables authorized communication between the web server 5 and the application server 11 (typically utilizing a secure socket layer (SSL) interface or an IPSec interface), while blocking unauthorized communication requests to the application server 11. In addition, the web server 5 preferably utilizes style sheets to build the HTML documents (and XML documents) for presentment to the employer web browser (or to the applicant web browser). The web server 5 may be realized by commercially available HTTP servers, such as the Apache Web Server, Microsoft Internet Information Server, and Sun ONE Web Server. In an alternative configuration, the web server 5 can be integrated as part of the application server 11 as is well known. Also note that web server 5 need not reside in the DMZ zone provided by the firewall router 13, but can process inbound requests from the communication network via port forwarding functionality supported by the firewall router 13 as is well known.

The application server 11 includes an employer application component 15, an applicant application component 17, matching logic 16, administration/configuration logic 19, a database 21 storing employer-job data and applicant data, presentation services 23, network security services 25, and messaging logic/services 27. The administration/configuration logic 19 provides for system management and configuration of the application server 11. The presentation services 23 are facilities that enable delivery of dynamic content to client browsers. Preferably, the presentation services 23 support active server pages, Java server pages, server-side scripting such as Perl, CGI, PL/SQL scripting, etc. The network security services 25 provide facilities that enable maintaining network security (such as SSL-based or IPSec-based encryption and authentication facilities). Preferably, the application server 11 is realized by a commercially-available software framework, such as the WebLogic platform commercially available from BEA Systems of San Jose, Calif., the Websphere application server commercially available from IBM, Windows server systems commercially available from Microsoft Corporation of Redmond, Wash., or the SUN ONE application server commercially available from Sun Microsystems of Santa Clara, Calif.

The database 21 maintains employer-job data that pertains to a respective employer as well as applicant data that pertains to a respective applicant and to matches of applicants to employer-jobs. In the illustrative embodiment shown, the employer data includes data about the employer as well as data about one or more job openings through the employer. The applicant data includes data about the applicant as well as data about the kind of job the applicant is seeking.

The employer application component 15, works in conjunction with the presentation services 23 and other components of the application server 11, to provide dynamic content to the web server 5 for delivery to the browser-based employer system 3. The employer application component 15 also encodes logic that allows for the respective employer to create and manage job listings and store information pertaining thereto in the database 21, which includes access to and/or presentation of matches of applicants to the job listing(s) as well as information provided by the applicants related thereto and a weighted ranking of the applicants.

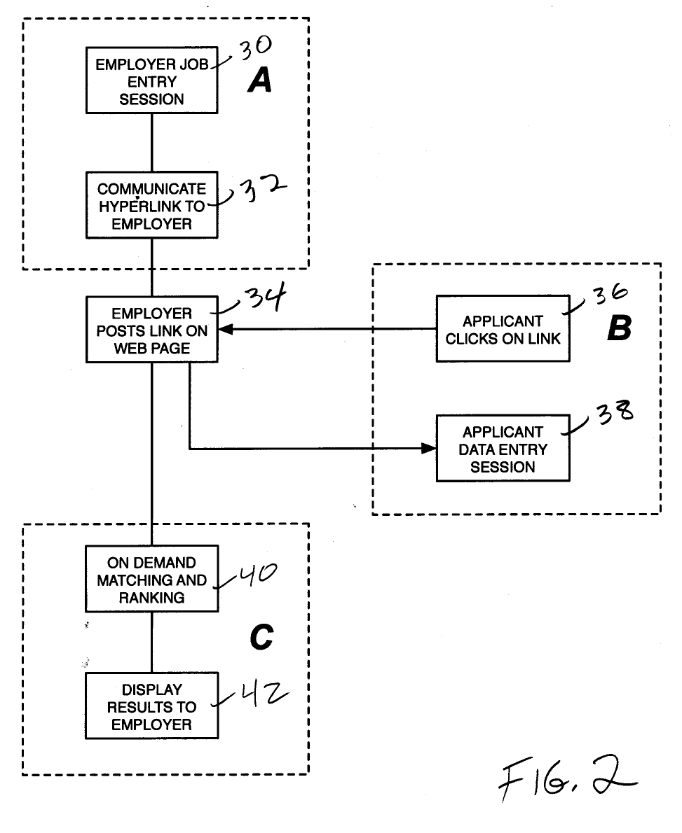

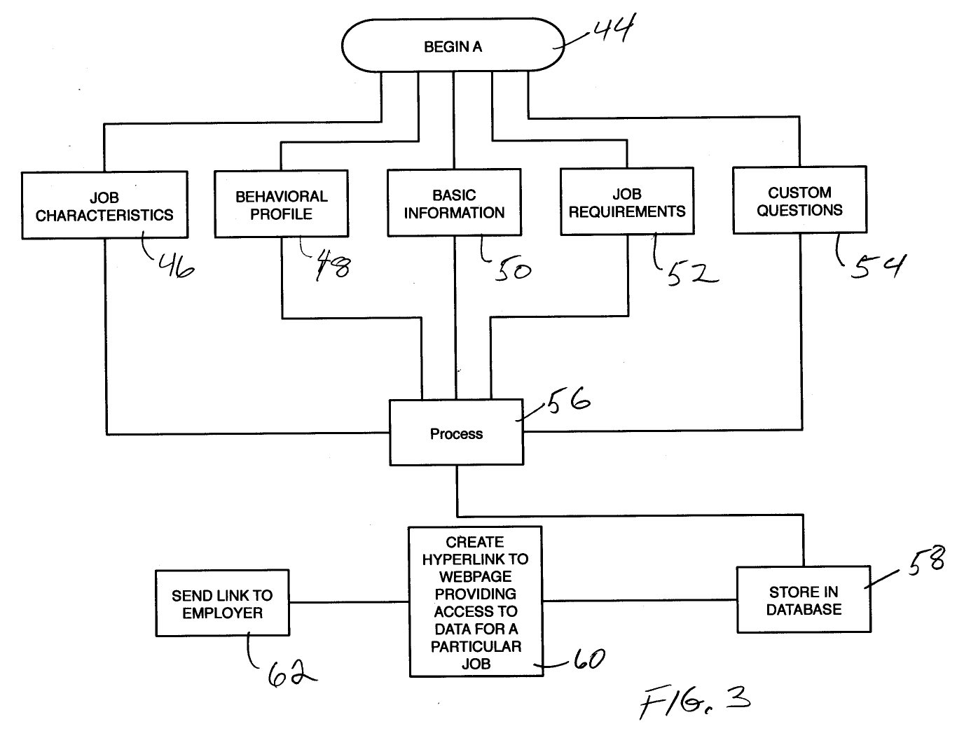

FIG. 2 illustrates an overview of the methods implemented by the system of FIG. 1. The methods can be divided into three main parts designated as “A”, “B”, and “C” in FIG. 2. In part A, the employer operates a browser on a networked computer system 3 to interact with web server 5 and application server 11 to perform a job entry session at 30. As part of the job entry session, the employer specifies information about a particular job opening (referred to herein as “job information”). The application server 11 stores the job information in the database 21. At 32, the application server 11 generates a Uniform Resource Locator (URL) associated with the particular job opening (referred to herein as “job-specific URL”), and communicates the job-specific URL to the employer (or other designated recipient) preferably as part of hyperlink. The job-specific URL points to a dynamic web page associated with the particular job opening that is made accessible by the web server 5 and application server 11. The job-specific URL (or hyperlink based thereon) can be placed anywhere that a job applicant will find it. According to the presently preferred embodiment, the job-specific URL (or a hyperlink based thereon) is integrated as part of the employer's web site as indicated at 34 in FIG. 2. In part B, a job applicant accesses the job-specific URL (for example, by clicking on a hyperlink based thereon) and is redirected to the web server 5 and application server 11 for an applicant data entry session at 38. As part of the applicant data entry session, the job applicant operates a browser on the networked computer system 9 to interact with the web server 5 and application server 11. Such interaction collects data about each given job applicant and stores the information in the database 21 and associates the job applicant with the particular job opening of the job-specific URL (the URL that initiated the data collection session with the given job applicant). In part C, the employer operates a browser on a networked computer system 3 to interact with web server 5 and application server 11 to request on demand matching and ranking at 40. The application server 11 invokes matching logic 16 to carry out a matching process that dynamically matches applicant information for one more job applicants with the job-specific information for a given job opening specified by the employer. The results of the matching process indicate whether any appropriate job applicants have been matched to the given job opening. The results of the matching logic 16 are presented to the employer at 42 preferably by interaction between the employer operating a browser on the networked computer system 3 and the web server 5 and application server 11. The results can be presented to the employer (preferably under selective control of the employer) as a list of job applicants in alphabetical order and/or in a ranked order based on how well the job applicants' information matches the job information for the given job opening. Each entry of the list preferably provides a hyperlink to a page that displays the information for the corresponding job applicant. FIGS. 3-5 illustrate parts A, B, and C in greater detail.

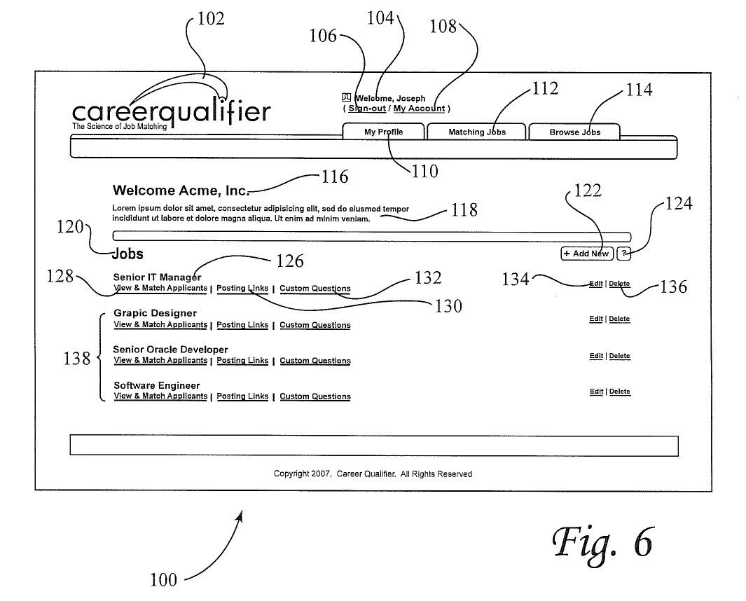

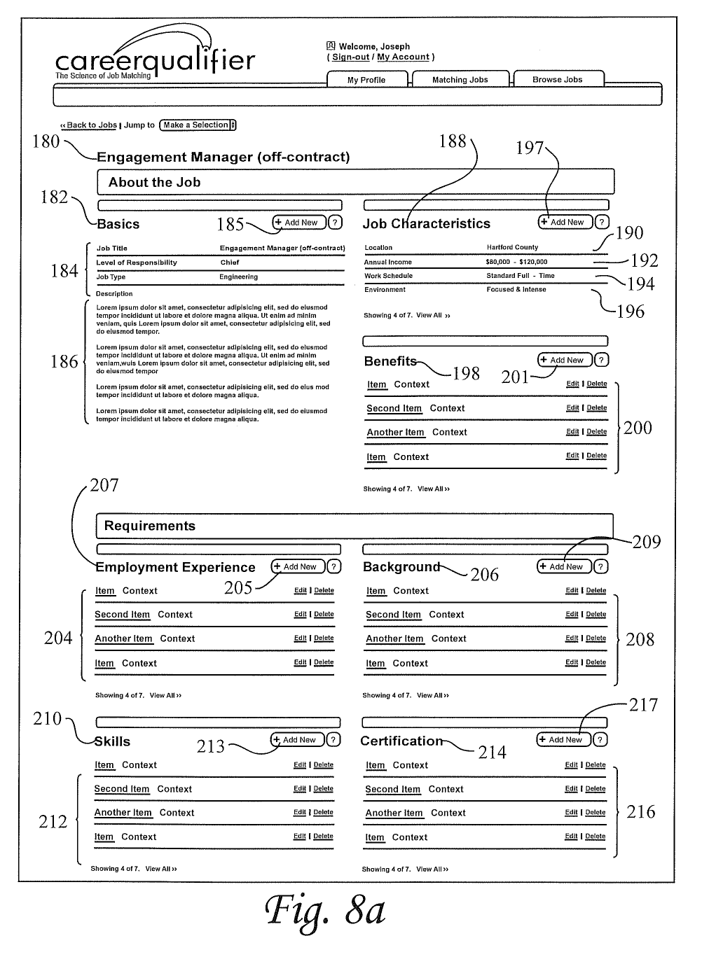

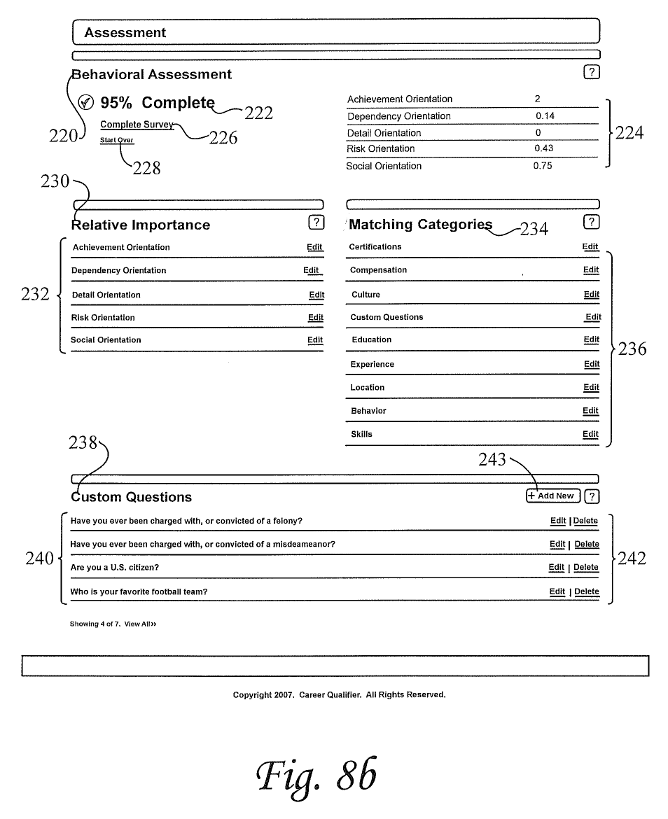

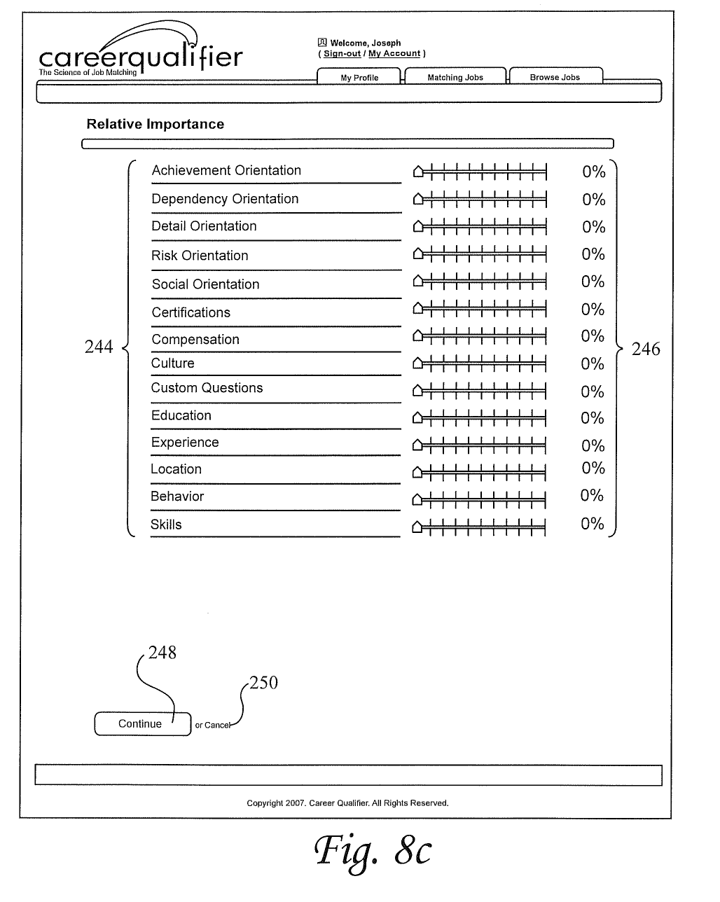

Turning now to FIG. 3, the employer job entry session begins at 44 where the employer is given access to five broad categories of information about the job opening and the employer: job characteristics 46, behavioral profile 48, basic information 50, job requirements 52, and custom questions 54. The basic information includes what is found in a typical job listing: job title, job function, name of employer, and employer industry. The job requirements include three sub-categories: education, skills, and certifications. Job characteristics include three sub-categories: salary/benefits, location, and work environment (work schedule, team environment, job environment, work content, and a description of the corporate culture). Behavioral profile includes a scaled rating on behavioral preferences such as: detail orientation, risk orientation, social orientation, dependency orientation and achievement orientation. Custom questions may include questions such as: “Have you ever been convicted of a crime?”, “Are you a U.S. citizen?”, “Do you have a driver's license?”, etc. As will be described in detail below with reference to FIGS. 6, 7, 8A, 8B, and 8C, the employer may access these categories in any order and some of the categories, e.g. custom questions, need not be accessed to create a job listing. According to the invention, the employer may assign a weight to any of the categories and sub-categories as described in more detail below with reference to FIGS. 8B and 8C. The weight represents a degree of relative importance between the categories and/or sub-categories.

All of the data input by the employer is processed at 56 and stored in a database 21 at 58. A job-specific URL (or a hyperlink based thereon) to a dynamic web page corresponding to the particular job opening accessible by the web server 5 and application server 11 is created at 60 and is communicated to the employer at 62. The job-specific URL (or hyperlink based thereon) can be displayed anywhere that an applicant is likely to look. According to the presently preferred embodiment, it is integrated on the employer's web site.

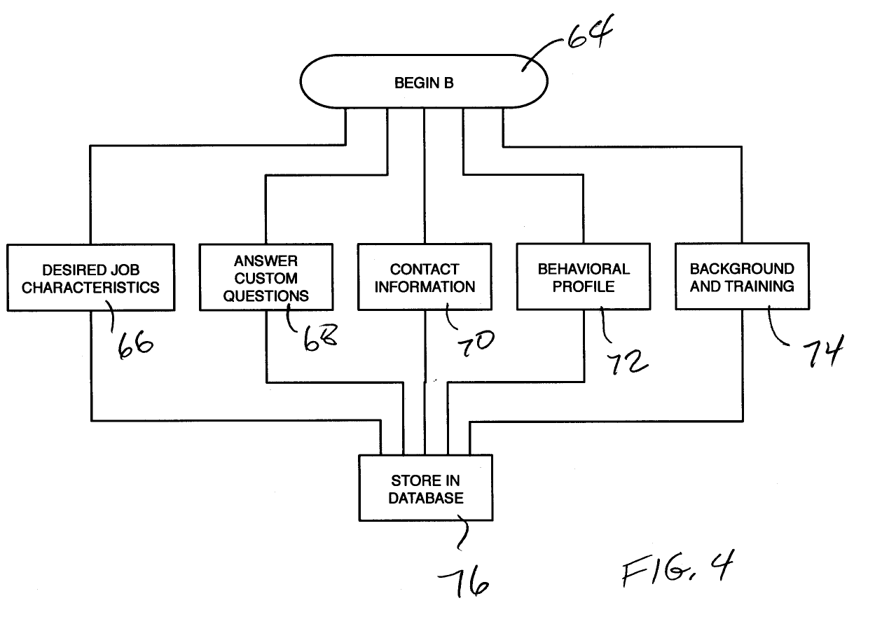

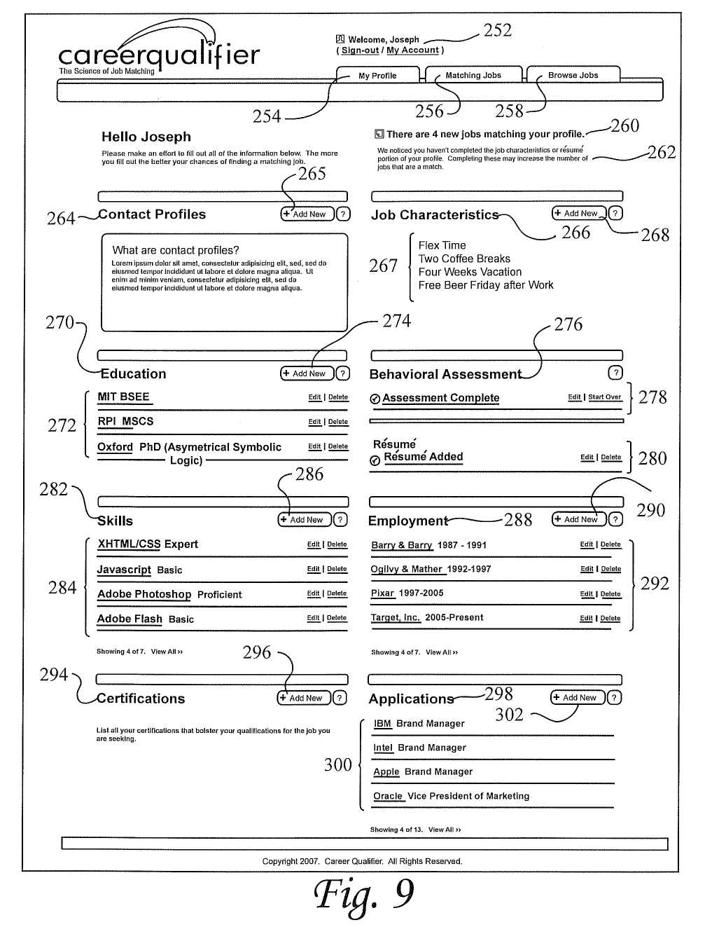

FIG. 4 illustrates the applicant data entry session that begins at 64. The applicant data entry session is preferably carried out after the job applicant clicks on the hyperlink based on the aforementioned job-specific URL), and is directed to the job listing and clicks on a link to apply for the job. In the applicant data entry session, the job applicant is provided access to five broad categories that correspond to the five broad categories presented to the employer in the job entry session that defined the job opening associated with the given job-specific URL. The categories include: desired job characteristics 66, answers to custom questions 68, contact information 70, behavioral profile 72, and background and training 74. The applicant information acquisition template (described in more detail below with reference to FIGS. 9-11) is tailored to the job information associated with job opening for the job-specific URL that was used to access the service by the job applicant. Thus, background and training entry fields will answer specific questions based on the job requirements input by the employer. For example, “Do you have a Masters degree in computer science?” The desired job characteristics entry fields will answer specific questions based on the job characteristics input by the employer. For example, “What is your minimum salary requirement?” The behavioral profile entry fields will answer specific requirements based on the behavioral profile input by the employer. For example, “Are you comfortable working alone?” The answers to custom questions will be the answers to the custom questions input by the employer.

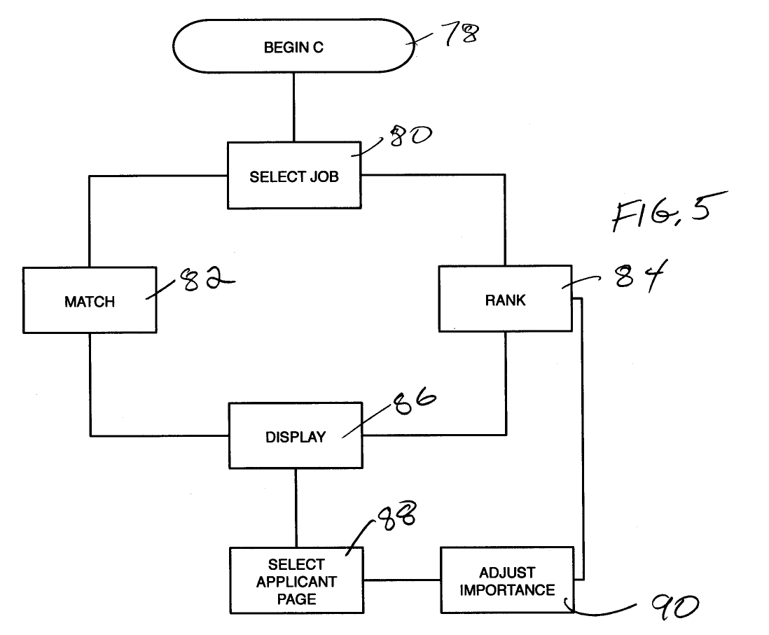

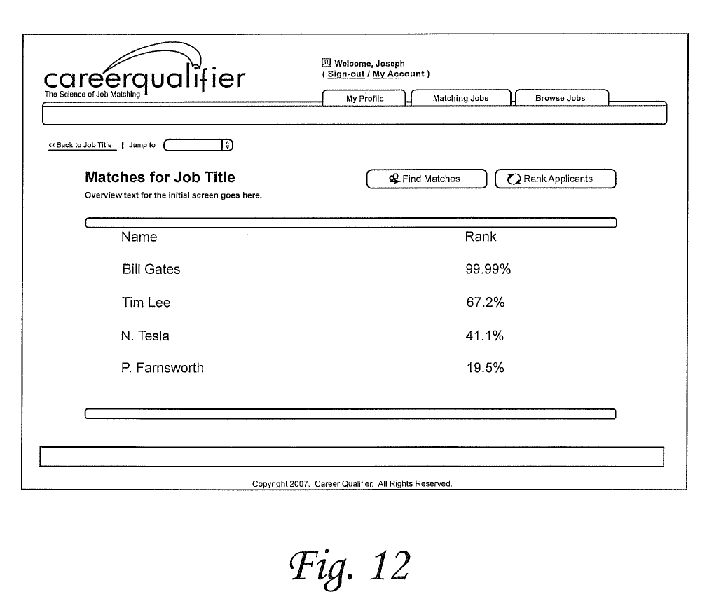

Referring now to FIG. 5, part C of the overall process begins at 78. At 80, the employer operates a browser on a networked computer system 3 to interact with web server 5 and application server 11 to select a job opening (or to create a new one), which is described in more detail below with reference to FIG. 6. When a job opening is selected at 80, the employer is given the options of matching applicants to the job at 82 or ranking applicants at 84. In either case, the matching logic 16 is invoked to carry out a matching process that dynamically matches applicant information for one more job applicants with the job-specific information for a given job opening. The results of the matching process indicate whether any appropriate job applicants have been matched to the given job opening. At 86, the results of the matching process are presented to the employer. In the event that the employer selected the matching option at 82, such results are presented as a list of job applicants in alphabetical order. Alternatively, in the event that the employer selected the ranking option at 84, such results are presented to the employer as a list of job applicants in a ranked order based on how well the job applicants' information matches the job information for the given job opening. (FIG. 12, described below). The matching process derives scores for job applicants in view of the details of the job opening as specified by the employer. The score for a given job applicant is preferably based on weights specified by the employer for the categories (and possibly sub-categories) of the job opening and by preferences specified by the given job applicant for certain job characteristics of the job opening. Thus, when the employer selects an applicant's data at 88 and reviews the applicant data, it may be desirable to adjust the employer-specified weights at 90 and rank the applicants again at 84.

When an employer logs in to the network system of FIG. 1, a graphical user interface is generated by the employer application logic 15 of the application server 11 and served to the employer computer 3 by the web server 5. FIGS. 6, 7, 8A, 8B, 8C, and 12, collectively, illustrate exemplary user interfaces generated by the employer application logic 15. The screen 100, shown in FIG. 6, includes advertising or the trademark of the provider of the service provider 102, a personal welcome message 104, sign off and account options 106, 108 as well as menu tabs 110, 112, 114. The menu tabs allow selection from among “my profile” 110, “matching jobs” 112, and “browse jobs” 114. Selecting tab 110 will allow the user to change either his personal profile or the profile of the employer that is indicated in the employer welcome message 116. Selecting tab 112 will list only the jobs for which matching applicants have been found. The screen shown in FIG. 6 is the result of selecting tab 114 and lists the jobs currently listed by the employer.

Below the employer welcome at 116 is a text message 118 which may be an indicator of the last time the account was accessed, the number of new matches found since the last access, or other notification. A job list follows under the title “Jobs” 120. To the right of the title are buttons 122, 124 for adding a new job description and for getting technical help. Each job in the list has a title, e.g. 126 “senior IT manager”. Beneath each job title are three hyperlinks to “view and match applicants” 128, “posting links” 130, and “custom questions” 132. The “posting links” hyperlink will display the hyperlink that is associated with this job, i.e. the link an applicant will use to find this job listing. This is the link that the employer can add to the employer's web site to advertise this particular job. To the right are hyperlinks 134, 136 for editing and deleting the job listing. Additional job listings 138 appear in a list that will scroll if the list is longer than what can be displayed in a single screen.

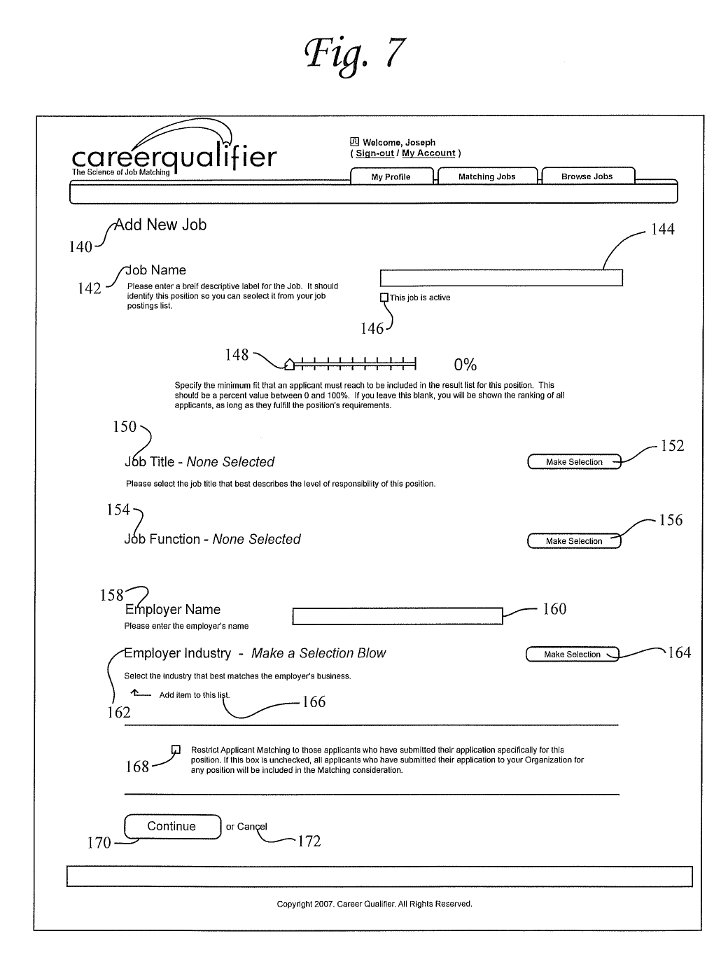

FIG. 7 illustrates the interface for entering basic information (see 50 in FIG. 3) about a new job opening. The web page is entitled “Add New Job” as shown at 140. The first required data is “Job Name” which is prompted at 142 and is entered in text entry field 144. A check box 146 is provided to activate the job listing. When the job is filled, the check box can be unchecked. If the job needs filling in the future, the job listing need not be reentered, only the check box needs to be checked. The next input is in the form of a slider 148 although other input devices such as radio buttons or a numeric entry field could be used. The slider 148 is used to set a minimum match score for the job listing. The minimum match score defines the minimum score that a job applicant must reach to be included in the list of job applicants generated in 82 or 84 of FIG. 5. The employer is prompted at 150 to select a job title by clicking on the button 152 that causes a list of job titles to be displayed for selection by clicking on a job title. Similarly, job function is prompted at 154 and selected at 156. The employer's name is prompted at 158 and is entered in the text entry field 160. Employer industry is prompted at 162 and is selected at 164. According to the invention, an employer may choose to match applicants to a job in two ways: (1) an applicant clicks on a job link to a particular job and the applicant is matched to that job, or (2) jobs are matched to a pool of applicants who have applied for any job with this employer. The employer can choose which method to use by checking check box 168. If the box is checked matching is limited to applicants who have applied for this specific job. When this form is completed the employer clicks on the button 170 to continue entering information about this job. If, for some reason, the employer decides to leave this form without saving any of the data, the employer can click on Cancel 172.

After the employer adds the basic information to the form of FIG. 7 and clicks on continue 170, the interface shown in FIGS. 8A-8C becomes available to specify more details about the job opening, the employer, the job requirements, behavioral assessment, custom questions for the job opening as well as the relative importance (i.e., weights) for the categories and sub-categories of the job opening for use in the matching process. Starting with FIG. 8A, the previously entered job title is displayed at 180. Three areas are provided to describe the job in more detail: Basics 182, Job Characteristics 188, and Benefits 198. The Basics area 182 displays some of the information 184 previously entered. If the employer wants to add to this short list of descriptors, clicking on the button 185 will bring up a list of short job descriptors that can be added to the list 184. In addition to the short descriptors, a text entry field 186 is provided to describe the job in a manner chosen by the employer. This text entry field is also a place where the employer can say something about the employer's behavioral characteristics while describing the job. For example, “this job requires working in a team environment”.

Job Characteristics 188 also presents a list of standardized short descriptors that are arranged in a list that can be expanded if desired. Items in this category include location 190, income 192, work schedule 194, and environment 196. The environment description also indicates something about the employer's behavioral characteristics while describing the job. For example, “quiet and focused business environment”.

Benefits 198 are presented as a separate section and include a list 200 of items that can be edited or deleted. Items can be added to the list using button 201. Though not shown in the drawing, the employer can create a custom benefit such as “free beer on Friday after work” or “use of the corporate jet”.

The following section concerns the job requirements and is divided into four parts: Employment Experience 202, Background 206, Skills 210, and Certifications 214. Employment Experience is a list of items 204 which can be edited, deleted, or added to using button 205. Similarly, Background 206 is a list of items 208 which can be edited, deleted, or added to using button 209. These items specify the educational background requirements (e.g., a particular type of undergraduate or graduate degree) for the job opening. Skills 210 is also a list of items 212 which can be edited, deleted, or added to using button 213 and Certifications 214 is also a list of items 216 which can be edited, deleted, or added to using button 217. The items in these four lists are automatically generated based on the information entered in the form of FIG. 7 and in the list 184 of Basics 182. In addition, when the employer uses the buttons 205, 209, 213, or 217, the employer is presented with an opportunity to enter “free form” items such as “must be at least six feet tall”, “must not be allergic to peanuts”, etc.

The next section, “Assessment” is particularly unique to the invention. Here the employer can describe the behavioral characteristics of the ideal candidate for the given job opening, assign weights to such behavioral characteristics, and assign weights to the categories of the job opening as provided in the previous sections. Here, also, the employer can enter custom questions for the given job opening. The behavioral characteristics are represented by scaled ratings on behavioral preferences such as: detail orientation, risk orientation, social orientation, dependency orientation and achievement orientation. Such behavioral preferences are particularly relevant to corporate culture and provide more accurate matching.

The behavioral assessment section 220 includes an indication 222 of completeness. The behavioral assessment section 220 is deemed complete when the employer completes a survey that is accessed via the link 226. The survey determines five characteristics 224. If at any time, the job requirements change, the employer can restart the survey via the link 228. The Relative Importance section 230 allows the employer to assign a relative importance to each of the behavioral characteristics obtained from the assessment. The illustrated interface shows a list 232 of each characteristic associated with an edit button for assigning a weight to each behavioral characteristic. In an illustrative embodiment, the edit button is used by the employer to assign a weight to a given behavioral characteristic as an integer value between 0 and 10. The Matching Categories section 234 presents a list 236 of the nine categories that characterize the job opening as described above, each associated with an edit button for assigning a weight to each category. In an illustrative embodiment, the edit button is used by the employer to assign a weight to a given category as an integer value between 0 and 10. The Custom Questions section 238 allows an employer to add custom questions for the given job opening using the button 243. The list of questions is displayed at 240, each associated with an edit and delete link 242.

FIG. 8C shows an alternative interface for assigning weights to the behavioral characteristics and nine categories for a given job opening. Here all of the five behavioral characteristics and nine matching categories are presented in a list 244 and each is associated with a slider 246. The employer enters weights by sliding the slider arrows from left to right. As the arrows are moved, the % display changes. When all of the weights have been assigned, they are entered into the system by clicking on the continue button 248. If the employer, for some reason chooses not to save the weights, the cancel button 250 can be used to exit.

FIGS. 9-11, collectively, illustrate exemplary graphical user interfaces generated by the applicant application logic 17 of the application server 11 and served by the server 5 to the applicant system 9 to enable the applicant to apply for a job opening. The illustrated interface assumes that the job applicant has already set up an account and is logged on viewing his profile. A similar interface can be provided by the applicant application logic 17 in response to a request for a job-specific URL where the job applicant has not yet set up an account on the system. In such a case, the job applicant user sets up and account and continues on to provide the required profile data. At the top of the page are welcome, log out and account settings links 252. Beneath are menu tabs 254, 256, 258 for viewing and editing the applicant's profile, displaying matching jobs, and browsing for jobs. Beneath the tab menu are messages to the applicant listing the number of new jobs matching the applicant's profile 260 and comments about incomplete portions of the applicant's profile 262.

The applicant's profile page includes eight categories: Contact Profiles 264, Job Characteristics 266, Education 270, Behavioral Assessment 276, Skills 282, Employment 288, Certifications 294, and Applications 298. Contact Profiles 264 allows the applicant to enter different contact information such as email address, fax number, post office address, cell phone number, etc. The applicant may also list times and days of the week when each contact profile should be used. For example, on weekends use the cell phone number, during business hours use the email address.

The Job Characteristics category 266 includes a list 267 of characteristics that the job applicant would like in an ideal job. Such characteristics can be related to salary, benefits, location, company culture, etc. work environment, vacation, location, etc. The job applicant is preferably provided with input means (for example a pull down menu (not shown)) to specify importance preferences (which represent a degree of relative importance) for each job characteristic in the list. In the preferred embodiment, the job applicant can identify any one of four importance preferences, which include “Unimportant,” Minimal,” “Preferable,” and “Required.” However, such importance preferences could be entered using a slider (see FIG. 8C).

The Education category 270 includes a list of degrees 272 and the names of the institutions that granted them. Each is associated with edit and delete links and new information can be added using the button 274. The job applicant is preferably provided with input means (for example a pull down menu (not shown)) to specify importance preferences (which represent a degree of relative importance) for using each degree in the list 272 in an ideal job. In the preferred embodiment, the job applicant can identify any one of four importance preferences, which include “Unimportant,” Minimal,” “Preferable,” and “Required.” However, importance preferences could be entered using a slider (see FIG. 8C).

The Behavioral Assessment category 276 indicates at 278 whether the behavioral assessment is complete and presents edit and start over links to allow the applicant to redo the assessment survey in whole or in part. This category also contains an indication at 280 of whether the applicant has uploaded a resume and provides links to edit or delete it.

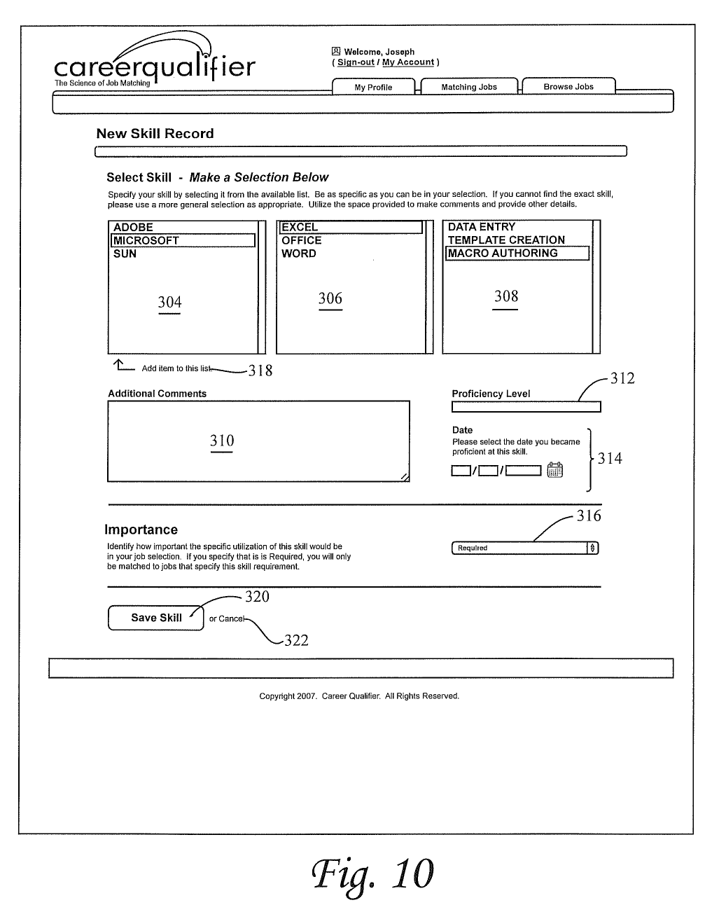

The Skills category 282 includes a list 284 of skills that the applicant has entered, an indication of the applicant's proficiency in each skill, and links to edit or delete skills from the list. New skills can be added using the button 286 as described below with respect to FIG. 10.

The Employment category 288 presents a list 292 of the applicant's past and present employers with an indication of start and end dates, each is also associated with edit and delete links. The button 290 allows the applicant to build the list and add to it. The job applicant is preferably provided with input means (for example a pull down menu (not shown)) to specify importance preferences (which represent a degree of relative importance) for using the job experience in the list 292 in an ideal job. In the preferred embodiment, the job applicant can identify any one of four importance preferences, which include “Unimportant,” Minimal,” “Preferable,” and “Required.” Such importance preferences could also be entered using a slider (see FIG. 8C).

The Certifications category 294 allows the applicant to list areas of certification. The list is built using the button 296 that links to an input interface such as that shown in FIG. 10 and described below. The job applicant can be provided with input means (for example a pull down menu (not shown)) to specify importance preferences (which represent a degree of relative importance) for using the certifications of the list in an ideal job. In the preferred embodiment, the job applicant can identify any one of four importance preferences, which include “Unimportant,” Minimal,” “Preferable,” and “Required.” Such importance preferences could also be entered using a slider (see FIG. 8C).

The category Applications 298 provides a list 300 of all of the currently pending jobs the applicant has for which the applicant has applied. The button 302 links to the same page as the menu tab 258. When the applicant clicks on any of the other “Add New” buttons, a data input screen such as that shown in FIG. 10.

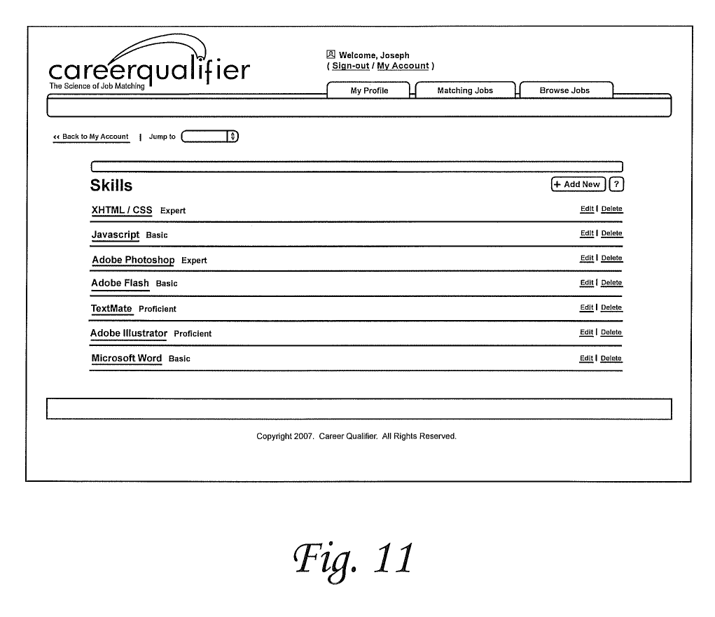

FIG. 10 illustrates the data input screen for an applicant to add a skill. The skills are selected from a hierarchical menu 304, 306, 306. In other words, the broad category of skill is selected from a list in list 304, then a subcategory of the skill is selected from list 306 and a sub-subcategory is selected from list 308. When applying for a particular job, the menus 304, 306, 308 will be pre-filled with the skills the employer has requested for the job (see 210, 212 in FIG. 8A). For example, as illustrated, menu 304 lists Adobe, Microsoft, and Sun with Microsoft having been selected by the applicant. Menu 306 lists three Microsoft products with the Excel having been selected by the applicant. Menu 308 lists three Excel skills with macro authoring having been selected by the applicant. After selecting a particular skill, the applicant may enter comments in text entry box 310. For example “I wrote the Excel Macro that automatically catalogs the entire inventory of Target stores.” For each skill, the applicant is required to enter a “proficiency level” at 312. Although illustrated as a text entry box, it is preferred to be a pull down menu with standardized levels such as “basic”, “proficient”, and “expert”. In order to determine whether the skill level is current, the applicant must enter the date at 314 indicating when the applicant achieved this proficiency level. In order to better match applicants to jobs, the job applicant is preferably provided with input means (e.g., pull down menu 316) to specify importance preferences (which represent a degree of relative importance) in utilizing each particular skill input by the job applicant as part of an ideal job. In the preferred embodiment, the job applicant can identify any one of four importance preferences in utilizing a particular skill, which include “Unimportant,” Minimal,” “Preferable,” and “Required.” Such importance preferences could also be entered using a slider (see FIG. 8C). If the applicant wants to add a skill that was not specified by the job description, the link 318 can be used to add a skill that the applicant believes the employer will appreciate. For example, fluent in Mandarin Chinese. When a skill has been entered, it is saved with button 320. To back out of the skill entry template link 322 is used. Templates similar to that shown in FIG. 10 are used to enter applicant information regarding educational and certifications requirements for a particular job. For example, if the employer has entered certain educational requirements for a job, then when the applicant clicks on the “add new” button 274 in FIG. 9, a template like the one in FIG. 10 will be displayed listing the degrees desired by the employer. Similarly with regard to certifications, when the applicant clicks on the button 296 in FIG. 9 the template will be preloaded with certifications listed by the employer when the job listing was created. When the applicant finishes entering skills, a screen listing the skills, such as that shown in FIG. 11, is displayed and presents buttons to edit, delete, and add skills. Similar screens are presented after entering education and certifications.

As described above, in the preferred implementation of the present invention, the job applicant can specify importance preferences (which represent a degree of relative importance, e.g., Unimportant, Minimal, Preferable, Required) of certain job characteristics in an ideal job through interaction between the job applicant and the server logic. Such job characteristics can be related to salary, benefits, location, company culture, education, experience, skills, and certifications. Such applicant-defined importance preferences are stored in the database and used by the matching logic in deriving the grades over the categories of the particular job. More particularly, the matching logic 16 of FIG. 1 is invoked to apply a matching process to the database for job listings and applicant profiles. In the preferred embodiment, the matching process is based on nine weighted criteria: certifications, compensation, culture, custom questions, education, experience, location, behavior, and skills. The result is a % match for each job-applicant pair. Each pair that has a % match above the threshold selected by the employer (see slider 148 in FIG. 7), is considered a match and is added to the employer's list and the applicant's list. FIG. 12 illustrates an example of a ranked list presented to an employer regarding a particular job listing for screening applicants for the particular job listing. A similar ranked list of jobs is available to an applicant who has qualified for one or more jobs. The applicant can choose that the list only display jobs for which the applicant has applied, only list jobs at an employer to which the applicant has applied, or list all jobs in the database for which the applicant has scored a match. The employer may be given similar options. In this manner, applicants can identify jobs without looking and employers can screen for applicants that did not see the advertisement on the employer's web site.

In the preferred implementation of the present invention, the matching logic 16 of FIG. 1 is invoked to apply a matching process based on nine categories: certifications, compensation, culture, custom questions, education, experience, location, behavior, and skills. The matching between a given job applicant and job opening is calculated separately in each category, as detailed below. The total match percentage over all categories is calculated using a linear weighted average with category weighting applied by the employer for the particular job as follows:

Applicant Match %=SUM((Category Match %)*(Category Weight))/SUM(Category Weight) (1)

The Category Weight may range from 0 to 10 for each category. Using this weighting mechanism, the employer may identify which categories are of particular importance for each given job, and which categories are not important. For instance, if all categories are of equal importance, the employer would leave them at an equal weight, usually defaulted to 5 (five). Conversely, if a category is of no importance at all for a job, the employer would set its weight to 0 (zero).

As described above, the networked system of the present invention preferably enables the employer to identify certain qualifications as being “Required” for the given job opening. These qualifications include specific skills, certifications, employment experience, educational background, and answers to job-specific questions. If a job applicant does not have a qualification which has been identified as “Required” by the employer, then he will be excluded from any further matching calculation for the job opening, and will not figure in the ranked list of applicants.

As described above, the networked system of the present invention also preferably enables the applicant to specify importance preferences that define relative importance (e.g., Unimportant, Minimal, Preferable, Required) of certain job characteristics of an ideal job. These characteristics include utilization of specific skills or certifications, job title or function, educational background requirement, as well as compensation, job location, and job culture. Such applicant-defined importance preferences are stored in the database and used by the matching logic in deriving the grades over the categories of the particular job. Generally, the applicant-defined importance preferences can be used to exclude the job applicant from consideration in certain job openings (e.g., where the job applicant has a specified a “Required” importance preference for a job opening that does not satisfy this requirement). They can also be used to selectively adjust the match score for certain job openings (e.g., lower the match score where the job applicant has a specified a “Preferable” importance preference for a job opening that does not satisfy this requirement).

In the preferred implementation of the present invention, the compensation category match percentage is determined based on salary and benefits information. The match percentage for salary and benefit are multiplied together to arrive at the total compensation match percentage.

The match percentage for salary is preferably derived as follows:
If a salary requirement is not specified by the job applicant or the salary for the job opening is not specified by the employer, or the applicant considers it “Unimportant,” then the match is considered to be 100%.
If the job applicant's salary requirement is met by the maximum salary for the job opening, then the match is considered to be 100%.
If the job applicant's salary requirement is greater than the maximum salary for the job opening, and compensation is of “Preferable” importance to the job applicant, then the match is equal to the job to applicant salary ratio squared.
If the job applicant's salary requirement is greater than the maximum salary for the job opening, and compensation is of “Minor” importance to the applicant, then the match is equal to the job to applicant salary ratio.

The match percentage for benefits is preferably derived as follows:
If the job applicant does not identify that he is looking for benefits in an ideal job, or considers compensation “Unimportant,” then the match is considered to be 100%.
If the job applicant identifies that he is looking for benefits in an ideal job, and the job opening as specified by the employer includes benefits, then the match is considered to be 100%.
If the job applicant identifies that he is looking for benefits in an ideal job, and the job opening as specified by the employer does not include benefits, and benefits is of “Preferable” importance to the applicant, then the match is equal to 50%.
If the job applicant identifies that he is looking for benefits in an ideal job, and the job opening as specified by the employer does not include benefits, and benefits is of “Minor” importance to the applicant, then the match is equal to 75%.

In the preferred implementation of the present invention, the location category match percentage is determined based on the regions and relocation options identified by the job applicant and the employer for the job opening as follows:
If the location is not defined in the preferences of the job applicant or not defined by the employer for the job opening, then the match is considered to be 100%.
If the region identified by the location preferences of the job applicant is identical to the region for the job opening as defined by the employer are identical, then the match is equal to 100%.
If the region identified by the location preferences of the job applicant is not identical to but within (i.e., overlaps) the region for the job opening as defined by the employer, then
   if the preferences of the job applicant indicate that the job applicant is willing to relocate, and the employer is willing to relocate the applicant that fills the job opening, then the match is equal to 100%;
   if the preferences of the job applicant indicate that the job applicant is willing to relocate, and the employer is not willing to relocate the applicant that fills the job opening, then the match is equal to 90%;
   if the preferences of the job applicant indicate that the job applicant is not willing to relocate, then the match is 80%.
If the region identified by the location preferences of the job applicant is not within (i.e., overlap) the region for the job opening as defined by the employer, then
   if location is of “Preferable” importance to the job applicant, and the bob applicant is willing to relocate, and the employer is willing to relocate the applicant that fills the job opening, then the match is equal to 25%;
   if location is of “Preferable” importance to the job applicant, and
   the job applicant is willing to relocate, and the employer is not willing to relocate the applicant that fills the job opening, then the match is equal to 15%;
   if location is of “Preferable importance to the job applicant, and the job applicant is not willing to relocate, then the match is 0%;
   if location is of “Minor” importance to the job applicant, and the job applicant is willing to relocate, and the employer is willing to relocate the applicant that fills the job opening, then the match is equal to 50%;
   if location is of “Minor” importance to the job applicant, and the job applicant is willing to relocate, and the employer is not willing to relocate the applicant that fills the job opening, then the match is equal to 35%;
   if location is of “Minor” importance to the job applicant, and the job applicant is not willing to relocate, then the match is 25%;
   if location is “Unimportant” to the job applicant, and the job applicant is willing to relocate, and the employer is willing to relocate the applicant that fills the job opening, then the match is equal to 75%;
   if location is “Unimportant” to the job applicant, and the job applicant is willing to relocate, and the employer is not willing to relocate the applicant that fills the job opening, then the match is equal to 60%;
   if location is “Unimportant” to the job applicant, and the job applicant is not willing to relocate, then the match is 50%.

In the preferred implementation of the present invention, the culture category match percentage is determined based on the answers to five questions related to the work environment, as specified by the job applicant. The questions are dictated by input from the employer for the job opening. The five selections identify:
Work schedule (such as full-time, part-time, flex hours)
Team environment (such as solo, small team, large team, department)
Job environment (such as quiet, focused, busy, wild)
Company culture (such as formal, business-like, entrepreneurial, informal)
Work content (such as established process, established business, new development, new business)
   Each of the five selections is compared, and given a fit from 0% to 20%. All five are then added together. If the job applicant has not made a selection, the fit is considered to be 20%. If the job applicant has made a selection, but the job opening does not specify a selection, then the fit is considered to be 15%. If the job applicant and the selection for the job opening are equal, then the fit is considered to be 20%. If the selection of the job applicant and the selection for the job opening are not equal, then the fit is considered to be 0%. The summed fit of the five selections will range from 0% to 100%. Finally, the importance of the culture category to the job applicant is considered in determining the final match percentage for the culture category as follows:
If job culture is of “Preferable” importance to the job applicant, then the match is equal to the fit summation.
If job culture is of “Minor” importance to the applicant, then the match is equal to ¾ (three quarters) of the fit summation plus 25%.
If job culture is “Unimportant” to the applicant, then the match is equal to ½ (one half) of the fit summation plus 50%.

In the preferred implementation of the present invention, the behavior category match percentage is determined based on the answers provided by the job applicant and the employer to a series of questions. The applicant test questions and the employer test questions are not the same. The questions posed to the job applicant seek to determine the applicant's behavioral attributes, while the questions posed to the employer seek to identify the attributes which would be optimal in a candidate for the specific position. The five behavioral attributes measured are achievement orientation, dependency orientation, detail orientation, risk orientation, and Social orientation. Each question addresses one of the behavioral attributes. The questions are posed so that the answers are picked from a selection of four choices. With each choice is associated a valuation ranging from −3 to +3. Whether the valuation is positive or negative depends on the phrasing of the question. The four answer choices, and their related valuation are as follows:
Absolutely Not Important (+3 or −3)
Not Important (+1 or −1)
Somewhat Important (−1 or +1)
Extremely Important (−3 or +3)
   The valuation of all answers for each behavioral attribute are averaged together to arrive at the applicant score and job score for the behavioral attribute. In order to determine the match percentage between applicant and job, first the fit of each behavioral attribute's scores is determined as follows:
If the absolute difference between applicant and job score is less than or equal to a lower fit limit, then the fit is 100%.
If the absolute difference between applicant and job score is greater than or equal to an upper fit limit, then the fit is 0%.
Otherwise, the fit is equal to (100%−(abs difference−lower fit limit)/(upper fit limit−lower fit limit)).
   The lower fit limit and upper fit limit are defined empirically, and may change based on validation of test questions in specific markets. The default settings are lower fit limit=0.66, and upper fit limit=3.39.

In addition to answering the behavioral test questions for each job, the employer may also specify the relative weighting of each behavioral attribute in the final determination of match percentage for the Behavior category. The five behavioral fit measurements are combined in a linear weighted average, to arrive at the behavior category match percentage as follows:

Behavior Category Match %=SUM((Behavioral Attribute Fit %)*(Attribute Weight))/SUM(Attribute Weight) (2)

The Behavioral Attribute Weight may range from 0 to 10 for each attribute. Using this weighting mechanism, the employer may identify which behavioral attributes are of particular importance for each given job, and which behavioral attributes are not important. For instance, if all behavioral attributes are of equal importance, the employer would leave them at an equal weight, usually defaulted to 5 (five). Conversely, if a behavioral attributes is of no importance at all for a job, the employer would set its weight to 0 (zero).

In the preferred implementation of the present invention, the education category match percentage is determined as the average of fit scores over all educational background requirements defined by the employer for the job opening. Each individual fit score is a calculation comparing the applicant's educational background and the particular educational background requirement for the job opening. Note that although in most cases there is only at best one educational background requirement defined for a job, the employer has the potential to add more. This may apply, for instance, to a job where an MBA as well as a professional degree would identify the best candidate, or where either one of two different degrees would suffice. For each educational background requirement of the job, the fit score is determined by comparing to each of the applicant's educational background records, and identifying the highest fit. Each individual fit is calculated as follows:
If the job educational background requirement does not include a degree specification, then the fit starts at 100%.
If the job educational background requirement includes a degree specification, then
   if the applicant record has no degree identified, then the fit is 0%;
   if the applicant's degree is equal to the job requirement, then the fit starts at 100%;
   if the applicant's degree is less than the job requirement, then the fit is 0%;
   if the applicant's degree exceeds the job requirement, and the applicant has identified use of this degree as being of Preferable importance, then the fit starts at 80%;
   otherwise, if the applicant's degree exceeds the job requirement, then the fit starts at 90%.
If the job educational background requirement includes a specification of the subject field, then the fit percentage arrived at previously is multiplied by the fit for this portion of the requirement as follows:
   if the applicant record has no field identified, then the fit is 0%;
   if the applicant's field is equal to the job field, then the fit multiplier is 100%;
   if the applicant's field does not cover the job field, i.e. is not at least a more specialized area of the job field, then the fit is 0%;
   if the applicant's field covers the job field, i.e. is a more specialized area of the job field, and the applicant has identified use of this field as being of Preferable importance, then the fit multiplier is 80%;
   otherwise, if the applicant's field covers the job field, i.e. is a more specialized area of the job field, then the fit multiplier is 90%.
If the job educational background requirement includes a specification of the graduating rank, then the fit percentage arrived at previously is multiplied by the fit for this portion of the requirement as follows:
   if the applicant record has no rank identified, then the fit multiplier is 50%;
   if the applicant's rank is equal to or exceeds the job required rank, then the fit multiplier is 100%;
   if the applicant's rank is less than the job required rank, then the fit is 0%.
If the job educational background requirement includes neither a degree, nor a field, nor a rank specification, then the descriptive entry for the job requirement is used as follows:
   if the applicant record has no description identified, then the fit is 0%;
   if the applicant's description does not include the job requirement description, then the fit is 0%;
   if the applicant's description includes the job requirement description, then the fit is 100%.

In the preferred implementation of the present invention, the experience category match percentage is determined as the average of fit scores over all experience requirements defined for the job. Each individual fit score is a calculation comparing the applicant's employment experience and the particular experience requirement. The employment experience requirement may be as simple as a number of years in a position, or may include job functional requirements, managerial level, and industry experience. For each experience requirement of the job, the fit score is determined by comparing to each of the applicant's employment experience records, and identifying the highest fit. Each individual fit is calculated as follows:
If the job experience requirement does not include a job function specification, then the fit starts at 100%.
If the job experience requirement includes a job function specification, then
   if the applicant record has no job function identified, then the fit is 0%;
   if the applicant's job function is equal to the job requirement, then the fit starts at 100%;
   if the applicant's job function does not cover the job requirement, i.e. is not at least a more specialized area of the job requirement, then the fit is 0%;
   if the applicant's job function covers the job requirement, i.e. is a more specialized area of the job requirement, and the applicant has identified use of this job function as being of “Preferable” importance, then the fit starts at 80%;
   otherwise, if the applicant's job function covers the job requirement, i.e. is a more specialized area of the job requirement, then the fit starts at 90%.
If the job experience requirement includes a specification of the number of years, then the fit percentage arrived at previously is multiplied by the fit for this portion of the requirement as follows:
   if the applicant record has no duration identified, then the fit multiplier is 50%;
   if the applicant's experience duration is equal to or exceeds the job required duration, then the fit multiplier is 100%;
   if the applicant's experience duration is less than the job required experience duration, then the fit is equal to the ratio of applicant's experience duration to job experience duration.
If the job experience requirement includes a specification of the title, i.e. the managerial level, then the fit percentage arrived at previously is multiplied by the fit for this portion of the requirement as follows:
   if the applicant record has no title identified, then the fit multiplier is 50%;
   if the applicant's title is equal to the job field, then the fit multiplier is 100%;
   if the applicant's title does not cover the job title, i.e. is not at least at the same level as the job title, then the fit multiplier is 50%;
   if the applicant's title is at the same level as the job title, then the fit multiplier is 90%;
   if the applicant's title exceeds the job title, and the applicant has identified use of this field as being of “Preferable” importance, then the fit multiplier is 70%;
   if the applicant's title exceeds the job title, and the applicant has identified use of this field as being of “Minor” importance, then the fit multiplier is 80%;
   otherwise, if the applicant's title exceeds the job title, then the fit multiplier is 90%.
If the job experience requirement includes a specification of the industry, then the fit percentage arrived at previously is multiplied by the fit for this portion of the requirement as follows:
   if the applicant record has no industry identified, then the fit multiplier is 50%, unless the job requirement had no job function specification, in which case the fit is 0%;
   if the applicant's industry is equal to the job requirement, then the fit multiplier is 100%;
   if the applicant's industry does not cover the job industry, i.e. is not at least a more specialized area of the job industry, then the fit multiplier is 50%, unless the job requirement had no job function specification, in which case the fit is 0%;
   if the applicant's industry does cover the job industry, i.e. is a more specialized area of the job industry, then the fit multiplier is 80%.
If the job experience requirement includes neither a job function, nor a number of years, nor a title, nor an industry specification, then the descriptive entry for the job requirement is used instead
   if the applicant record has no description identified, then the fit is 0%;
   if the applicant's description does not include the job requirement description, then the fit is 0%;
   if the applicant's description includes the job requirement description, then the fit is 100%.

In the preferred implementation of the present invention, the skill category match percentage is determined as the average of fit scores over all skill requirements defined for the job opening. Each individual fit score is a calculation comparing the applicant's skills and the particular skill requirement. For each skill requirement of the job opening, the fit score is determined by comparing to each of the applicant's skill records, and identifying the highest fit. Each individual fit is calculated as follows:
If the skill requirement does not include a skill specification, then the fit starts at 100%.
If the skill requirement includes a skill specification, then
   if the applicant record has no skill identified, then the fit is 0%;
   if the applicant's skill is equal to the skill requirement, then the fit starts at 100%;
   if the applicant's skill does not cover the skill requirement, i.e. is not at least a more specialized area of the skill requirement, then the fit is 0%;
   if the applicant's skill covers the skill requirement, i.e. is a more specialized area of the skill requirement, and the applicant has identified use of this skill as being of Preferable importance, then the fit starts at 80%;
   otherwise, if the applicant's skill covers the skill requirement, i.e. is a more specialized area of the skill requirement, then the fit starts at 90%;
If the skill requirement includes a specification of the proficiency level, where the level is numerically rated from 1 to 5, corresponding from Novice to Expert, then the fit percentage arrived at previously is multiplied by the fit for this portion of the requirement as follows:
   if the applicant record has no proficiency identified, then the fit multiplier is 50%;
   if the applicant's proficiency is equal to or exceeds the required proficiency, then the fit multiplier is 100%;
   if the applicant's proficiency is less than the required proficiency, then the fit multiplier is 100%−25%*(number of levels less).
If the skill requirement is only identified by a descriptive entry, then this is used as follows:
   if the applicant record has no description identified, then the fit is 0%;
   if the applicant's description does not include the job requirement description, then the fit is 0%;
   if the applicant's description includes the job requirement description, then the fit is 100%.

In the preferred implementation of the present invention, the certification category match percentage is determined as the average of fit scores over all certification requirements defined for the job opening. Each individual fit score is a calculation comparing the applicant's certifications and the particular certification requirement. For each certification requirement of the job, the fit score is determined by comparing to each of the applicant's certification records, and identifying the highest fit. Each individual fit is calculated as follows:
If the certification requirement includes a certification specification, then
   if the applicant record has no certification identified and has no descriptive text which includes the certification, then the fit is 0%;
   if the applicant's certification is equal to the certification requirement, or has descriptive text which includes the certification, then the fit is 100%.
If the certification requirement is only identified by a descriptive entry, then
   if the applicant record has no certification identified and has no descriptive text which includes the certification description, then the fit is 0%;
   if the applicant's certification is contained in the certification requirement description, or has descriptive text which includes the certification description, then the fit is 100%.

In the preferred implementation of the present invention, the employer may define any number of custom questions for his organization. Each of these questions can be given a defined set of answers, which an applicant might select from. Each answer can be compared to each other answer for the question, and that combination assigned a fit percentage. Each question can also be assigned a weight relative to other questions. For each job opening, the employer has the option to select any or all of the question defined for his organization, and include them in the job profile, providing a preferred answer to the question for this job opening. Each applicant to that job opening will then be asked to provide answers to these questions. The Custom Question category match percentage is determined as the linear weighted average of fit scores over all custom questions defined for the job. Each individual fit score is a calculation comparing the applicant's answer with the preferred answer as selected by the employer, using the fit percentage provided for this combination by the employer when the question was defined as follows:

Custom Question Category Match %=SUM((Custom Question Fit %)*(Question Weight))/SUM(Question Weight) (3)

Advantageously, the networked system of the present invention allow for matching and screening job applicants to particular job openings of one or more employers in a manner that combines traditional measurements of job requirements with measurements of company culture and behavioral components. Such measurements are examined in matching (and/or ranking) each job applicant's fit for a particular job opening. The matching process for a particular job opening can be adjusted by the employer such that it emphasizes (or de-emphasizes) one or more of the measurements in the matching process. Moreover, the preferred implementation of the system employs nine measures or categories in the matching process, the nine categories including: 1) behavioral assessment; 2) custom questions (can be company-specific or job-specific questions); 3) skills; 4) experience; 5) company culture; 6) location preferences; 7) certifications; 8) education; and 9) compensation. The nine categories enable the employer to efficiently identify the better matching job applicants and remove other job applicants from consideration.

There have been described and illustrated herein several embodiments of a method, system and apparatus for matching job applicants with jobs and employers. While particular embodiments of the invention have been described, it is not intended that the invention be limited thereto, as it is intended that the invention be as broad in scope as the art will allow and that the specification be read likewise. Thus, while particular application server architectures have been disclosed, it will be appreciated that other architectures for web-based services can be used as well. In addition, while particular schema and data have been disclosed for matching computer science professionals with jobs, it will be understood that the logic, systems and apparatus as described herein can be used for matching any kind of job and applicant. Moreover, while particular graphical user interface elements have been disclosed, it will be appreciated that other graphical user interface elements can be used as well. It will therefore be appreciated by those skilled in the art that yet other modifications could be made to the provided invention without deviating from its spirit and scope as claimed.

What is claimed is:

1. A method for matching an applicant with an employer and a job opening, comprising:
an employer using a browser to interact with a networked system to specify data defining a specific job opening;
storing the data in a database; and
communicating a URL (uniform resource locator) to the employer, the URL associated with the specific job opening and providing access to the data stored in the database.

2. A method according to claim 1, further comprising:
the employer integrating the URL on the employer's web site; and
an applicant using a browser to interact with the URL integrated as part of the employer's web site to cause redirection to the networked system.

3. A method according to claim 1, wherein:
the data stored in the database for a particular job opening comprises a number of categories selected from the group consisting of applicant certifications, compensation, corporate culture, custom questions, applicant education, applicant experience, job location, behavioral characteristics of the applicant, and applicant skills.

4. A method according to claim 3, wherein:
the employer uses a browser to interact with the networked system to assign a weight to at least one of the categories for a particular job opening.

5. A method according to claim 4, wherein:
the applicant uses a browser to interact with the networked system to specify data regarding one or more of said categories.

6. A method according to claim 5, wherein:
the applicant uses a browser to interact with the networked system to assign at least one importance preference to corresponding job characteristics.

7. A method according to claim 6, further comprising:
the networked system matching data specified by the applicant with specified by the employer, wherein the matching assigns a match score to the applicant, the match score based upon the weights assigned by the employer and the at least one importance preference assigned by the applicant.

8. A method according to claim 7, wherein:
multiple applicants use browsers to interact with the networked system to specify data regarding one or more of said categories;
the networked system matches data specified by the employer with data specified by each applicant to derive a match score assigned to each applicant; and
the network system displays a list of applicants to the employer, the list being arranged according to match score.

9. A method according to claim 8, wherein:
the employer sets a threshold match score such that applicants who score below the threshold will not be displayed on the list.

10. A method according to claim 9, wherein:
the applicants enter data regarding their job preferences.

11. A method according to claim 3, wherein:
said behavioral characteristics are selected from the group consisting of detail orientation, risk orientation, social orientation, dependency orientation and achievement orientation.

12. A system for matching an applicant with an employer and a job opening, said system comprising:
means for interacting with an employer over a communication network to specify data defining a specific job opening and characteristics of the employer;
a database for storing said data; and
means for communicating a URL (uniform resource locator) to the employer, the URL associated with the specific job opening and providing access to the data stored in said database.

13. A system according to claim 12, wherein:
the data stored in the database for a particular job opening comprises a number of categories selected from the group consisting of applicant certifications, compensation, corporate culture, custom questions, applicant education, applicant experience, job location, behavioral characteristics of the applicant, and applicant skills.

14. A system according to claim 13, further comprising:
means for interacting with the employer of a communication network to assign at least one weight to corresponding categories for a particular job opening.

15. A system according to claim 14, further comprising:
means for interacting with the applicant over a communication network to specify data regarding one or more of said categories.

16. A system according to claim 15, further comprising:
means for interacting with the applicant over a communication network to assign at least one importance preference to corresponding job characteristics.

17. A system according to claim 16, wherein:
the networked system includes matching logic for matching data specified by the applicant with data specified by the employer, wherein the matching assigns a match score to the applicant, the match score based upon the at least one weight assigned by the employer and the at least one importance preference specified by the applicant.

18. A system according to claim 17, further comprising:
means for interacting with multiple applicants over a communication network to specify data regarding one or more of said categories; and
means for matching data specified by the employer with data specified by each applicant to derive a match score assigned to each applicant; and
means for displaying a list of applicants to the employer, the list being arranged according to match score.

19. A system according to claim 18, wherein:
means for interacting with the employer over a communication network to set a threshold match score such that applicants who score below the threshold will not be displayed on the list.

20. A system according to claim 19, further comprising:
means for interacting with applicants over a communications network to specify data regarding their job preferences.

21. A system according to claim 13, wherein:
the behavioral characteristics are selected from the group consisting of detail orientation, risk orientation, social orientation, dependency orientation and achievement orientation.

22. A method for matching an applicant with an employer and a job, comprising:
an employer using a browser to interact with a networked system to specify data defining a specific job opening;
storing the data in a database;
an applicant using a browser to interact with said networked system to access the data stored in the database for the specific job opening;
the applicant using a browser to interact with said networked system to specify behavioral characteristics of the applicant; and
the networked system matching data specified by the applicant with data specified by the employer, wherein the matching utilizes the behavioral characteristics of the applicant as specified by the applicant.

23. A method according to claim 22, wherein:
the behavioral characteristics are selected from the group consisting of detail orientation, risk orientation, social orientation, dependency orientation and achievement orientation.

24. A method for matching an applicant with an employer and a job, comprising:
an employer using a browser to interact with a networked system to specify data defining a specific job opening, the data pertaining to a plurality of categories and including at least one weight assigned by the employer and corresponding to said categories;
storing the data in a database;
an applicant using a browser to interact with said networked system to access the data stored in the database for the specific job opening;
the applicant using a browser to interact with said networked system to specify applicant data, the applicant data corresponding to said categories and including at least one importance preference associated with corresponding job characteristics;
storing said applicant data in the database;
the networked system matching applicant data specified by the applicant with data specified by the employer, wherein the matching assigns a match score to the applicant, the match score based upon the at least one weight assigned by the employer and the at least one importance preference specified by the applicant.

25. A method according to claim 24, wherein:
multiple applicants use browsers to interact with the networked system to specify data regarding one or more of said categories;
the networked system matches data specified by the employer with applicant data specified by each applicant to derive a match score assigned to each applicant; and
the network system displays a list of applicants to the employer, the list being arranged according to match score.

26. A method according to claim 25, wherein:
the employer sets a threshold match score such that applicants who score below the threshold will not be displayed on the list.
